(19) United States
(12) Patent Application Publication
(10) Pub. No.: US 2020/0203807 A1
(43) Pub. Date: Jun. 25, 2020

(54) ANTENNA MODULE AND MOBILE TERMINAL

(71) Applicant: AAC Technologies Pte. Ltd., Singapore city (SG)

(72) Inventors: Jing Wu, Shenzhen (CN); Haibing Chen, Shenzhen (CN); Ke Hua, Shenzhen (CN)

(21) Appl. No.: 16/699,703

(22) Filed: Dec. 1, 2019

(30) Foreign Application Priority Data
Dec. 24, 2018 (CN) 201811580754.3

(51) Int. Cl. H01Q 1/24; H01Q 23/00

(52) U.S. Cl. CPC H01Q 1/243; H01Q 23/00

(57) ABSTRACT

An antenna module and a mobile terminal are provided. The antenna module is used for a mobile terminal having a metal frame and a system grounding spaced apart from the metal frame. The antenna module has a radiating body formed on the metal frame and a parasitic element electrically connected to the system grounding and coupled to the radiating body. The antenna module supports carrier aggregation of the LTE low frequency harmonic, the LTE medium frequency harmonic and the LTE high frequency harmonic. The antenna module further includes a capacitor connected in series between the parasitic element and the system grounding, and a capacitance of the capacitor is less than 0.8 pF. The antenna module of the present invention covers all the LTE low, medium and high frequency bands as a single antenna, and has enhanced performance in low frequency.

### FIELD OF THE PRESENT INVENTION

The present invention relates to the field of communication technology, and more particularly to an antenna module and a mobile terminal using the antenna module.

### DESCRIPTION OF RELATED ART

As the development of communication technology, cell phones, PADs and laptops have gradually become essential electronic products in our life. These electronic products are all implemented with an antenna module such that they can have communication function.

Design of size and appearance of a mobile terminal is one important focus nowadays. In order to meet users' requirement, current mobile terminals are usually designed to have a bezel-less screen, a glass back cover and a metal frame. A communication device with a bezel-less screen may only provide very small clearance space or even no clearance space, which may deteriorate the performance and band width of a single antenna and brings large difficulty to design of low frequency coverage and carrier aggregation (CA). Furthermore, as the fifth-generation communication is coming, mobile communication terminals would support a transmitting system with more Multiple-Input Multiple-Output (MIMO) antennas for cell phones in order to raise transmission speed and increase transmission capacity, which means the antenna arrangement of cell phones would be upgraded from 2*2 or 4*4 to 8*8. This gives further difficulties to antenna design.

Therefore, a new antenna module is required to solve the above problems.

### BRIEF DESCRIPTION OF THE DRAWINGS

In order to clearly explain the technical solutions in the embodiments of the present invention, the drawings used in the description of the embodiments will be briefly described below. Obviously, the drawings in the following description are merely some embodiments of the present invention. For those of ordinary skill in the art, other drawings may also be obtained based on these drawings without any creative work.

FIG. 1 is an isometric view of a portion of a mobile terminal according to a first embodiment of the present invention.

FIG. 2 is a schematic diagram of an antenna module implemented in a mobile terminal according to the first embodiment of the present invention.

FIG. 3 is a schematic diagram of an antenna module implemented in a mobile terminal according to a second embodiment of the present invention.

FIG. 4 is a schematic diagram of an antenna module implemented in a mobile terminal according to a fourth embodiment of the present invention.

FIG. 5 is a schematic diagram of an antenna module implemented in a mobile terminal according to a fifth embodiment of the present invention.

FIG. 6 illustrates a simulation result of radiating efficiency of an antenna module according to the first embodiment of the present invention.

FIG. 7 illustrates the comparation of radiating efficiencies in the situation where the parasitic element is short-circuited to ground and in the situation where the parasitic element is grounded via a capacitor.

### DETAILED DESCRIPTION OF THE EXEMPLARY EMBODIMENT

The disclosure will now be described in detail with reference to the accompanying drawings and examples. Apparently, the described embodiments are only a part of the embodiments of the present invention, not all of the embodiments. All other embodiments obtained by a person of ordinary skill in the art based on the embodiments of the present invention without creative efforts shall fall within the protection scope of the present invention.

### First Embodiment

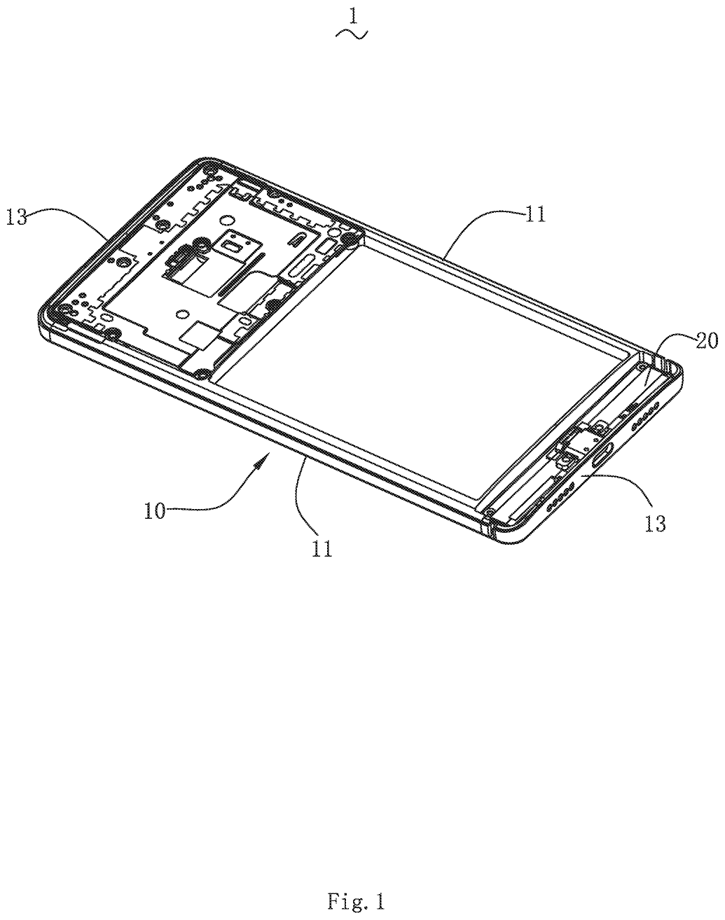

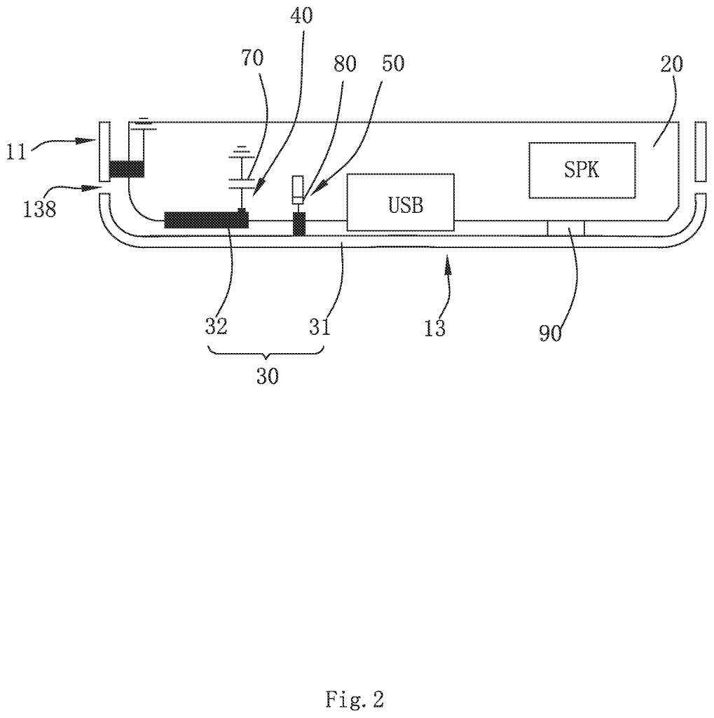

As shown in FIGS. 1 and 2, the present invention provides a mobile terminal 1. The mobile terminal 1 may be a cell phone, tablet computer, multi-media player etc. In order to be advantageous for understanding, the cell phone will be taken as an example in following embodiments.

The mobile terminal 1 includes a metal frame 10, a system grounding 20 spaced apart from the metal frame 10 and an antenna module 30.

The metal frame 10 includes a longer side frame 11 and a shorter side frame 13. The longer side frame 11 and the shorter side frame 13 are connected successively to consist the metal frame 10. The metal frame 10 further defines a gap 138 and a connector 90 which is connected to the system grounding 20.

The antenna module 30 includes a radiating body 31 formed on the metal frame 10 and a parasitic element 32 coupled to the radiating body 31. Specifically, the radiating body 31 is located between the connector 90 and the gap 138. The parasitic element 32 is a metal layer electrically connected to the system grounding 20. The radiating body 31 is capable of generating an LTE low frequency harmonic. The parasitic element 32 is capable of generating an LTE medium frequency harmonic and an LTE high frequency harmonic, and supporting carrier aggregation of the LTE low frequency harmonic, LTE medium frequency harmonic and LTE high frequency harmonic.

The LTE low frequency harmonic covers 698-960 MHz. The LTE medium frequency harmonic covers 1710-2170 MHz. The LTE high frequency harmonic covers 2300-2690 MHz. The antenna module 30 realizes full coverage of the LTE low, medium and high frequency bands with a single antenna, and achieves carrier aggregation of different frequency bands.

Generally, since the capacitive coupling effect between the parasitic element 32 and the system grounding 20 deviates the frequency of the low frequency harmonic to a lower value, the diameter of the radiator for low frequency need to be reduced, which deteriorates low frequency performance. However, in this embodiment, the antenna module 30 further has a capacitor 70 with a small capacitance is connected in series between the parasitic element 32 and the system grounding 20 in order to reduce interference of the parasitic element 32 on low frequency and improve low frequency performance. This arrangement reduces influence of the parasitic element 32 on low frequency and improves the low frequency performance of the antenna module 30. In some embodiments, the capacitance of the capacitor 70 may be less than 0.8 PF. In other words, the capacitor 70 is connected in series to the coupling capacitor between the parasitic element 32 and the radiating body 31 so as to reduce interference to low frequency.

In this embodiment, the connector 90 is connected to the shorter side frame 13. Thus, the gap 138 is located in the longer side frame 11. The radiating body 31 is consisted by the shorter side frame 13 and a portion of the longer side frame 11 adjacent to the shorter side frame 13. The parasitic element 32 has an elongated configuration.

The antenna module 30 further includes a feed line 50 connected to the shorter side frame 13 and a parasitic line 40 which connects the parasitic element 32 and the system grounding 20. The parasitic line 40 is located at an end of the parasitic element 32 close to the feed line 50. The capacitor 70 is connected to the parasitic line 40 in series. The parasitic element 32 is located at a side of the feed line 50 away from the connector 90.

In order to tune the low frequency harmonic, the feed line 50 has a tuning circuit 80 for tuning the low frequency harmonic. Coverage of multiple harmonics further improve the performance in low frequency bands.

In this embodiment, the antenna module only takes a small space of the mobile terminal. A distance between the connector 90 and an end of the radiating body 31 away from the connector 90 may be no larger than ⅔ of a length of the shorter side frame 13. The distance here refers to a distance in the short axis direction.

Moreover, in this embodiment, the system grounding 20 and the shorter side frame 13 is spaced apart to form a clearance zone. In this embodiment, the clearance zone is a small clearance. Specifically, the width of the clearance zone is less than 2 mm (in a direction from the system grounding 20 to the shorter side frame 13).

### Second Embodiment

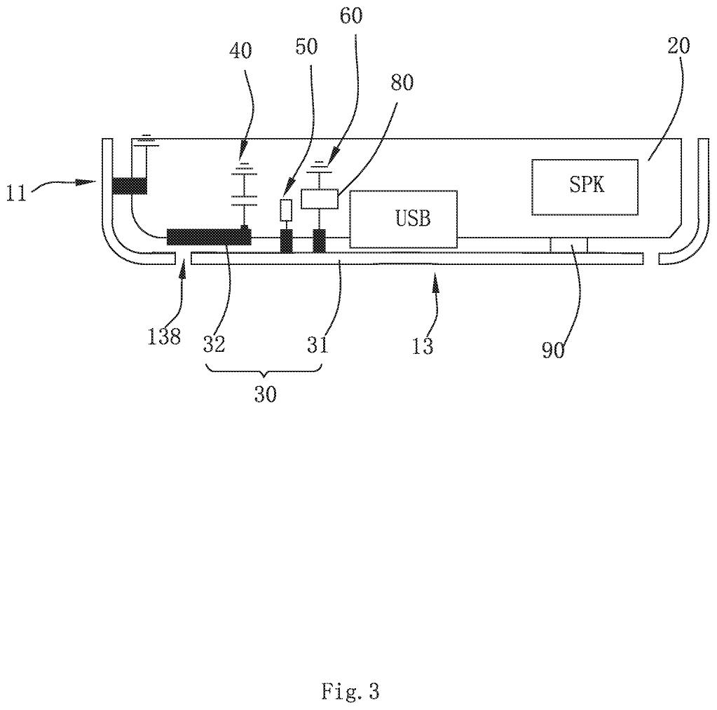

Referring to FIG. 3, the difference between the second embodiment and the first embodiment lies on that the gap 138 is located in the shorter side frame 13. That is, the radiating body 31 is formed only by the shorter side frame 13. Further, in this embodiment, the antenna module further includes a grounding line 60, and the tuning circuit 80 set in the grounding line 60.

### Third Embodiment

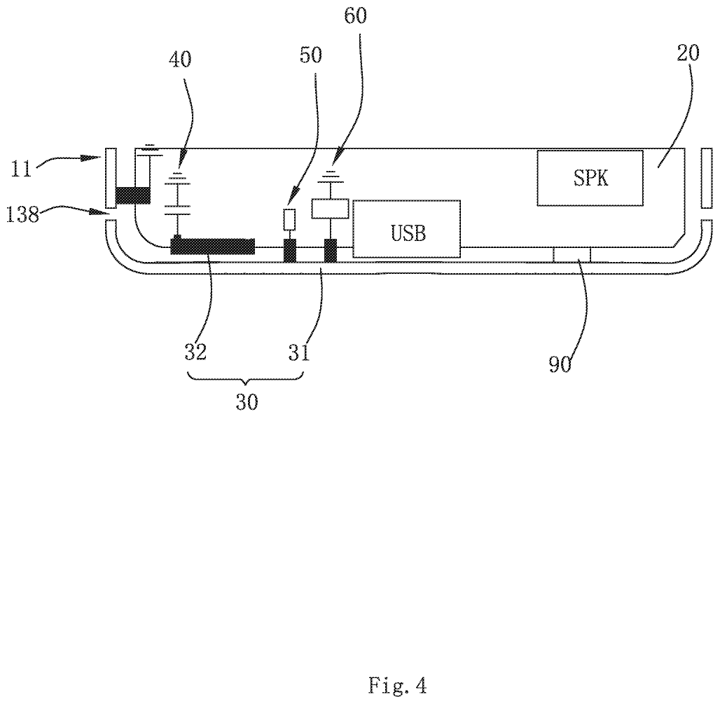

Referring to FIG. 4, the difference between the third embodiment and the second embodiment lies on that the parasitic line 40 is located at an end of the parasitic element 32 away from the feed line 50, and the gap 138 is located in the longer side frame 11.

### Fourth Embodiment

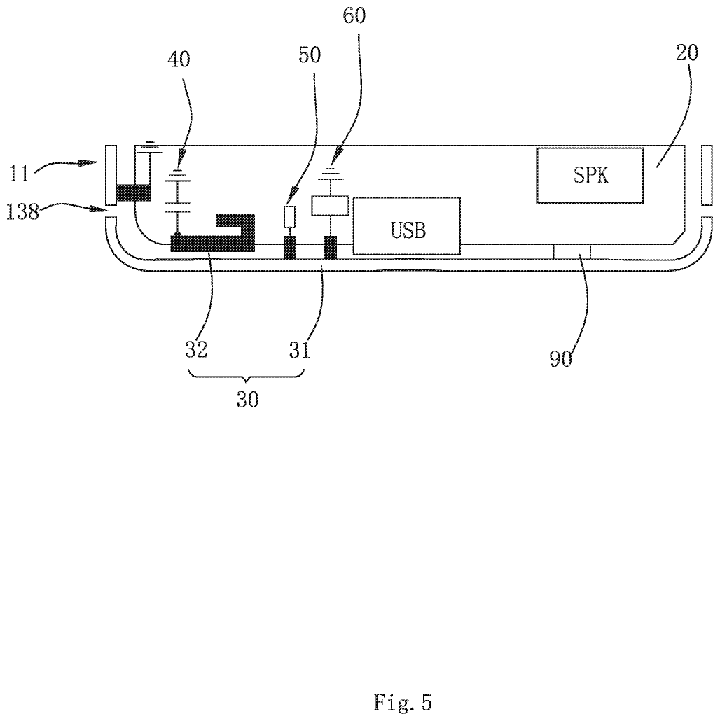

Referring to FIG. 5, the difference between the fourth embodiment and the third embodiment lies on that the parasitic element 32 includes an elongated portion connected to the parasitic line 40 and a bending portion formed at an end of the elongated portion and pointing away from the parasitic line 40.

The fourth embodiments described above are merely some embodiments of the present invention. The position of the radiating body 31 is not limited in the present invention. If necessary, the radiating body 31 or most parts of the radiating body 31 may be located on the longer side frame 11.

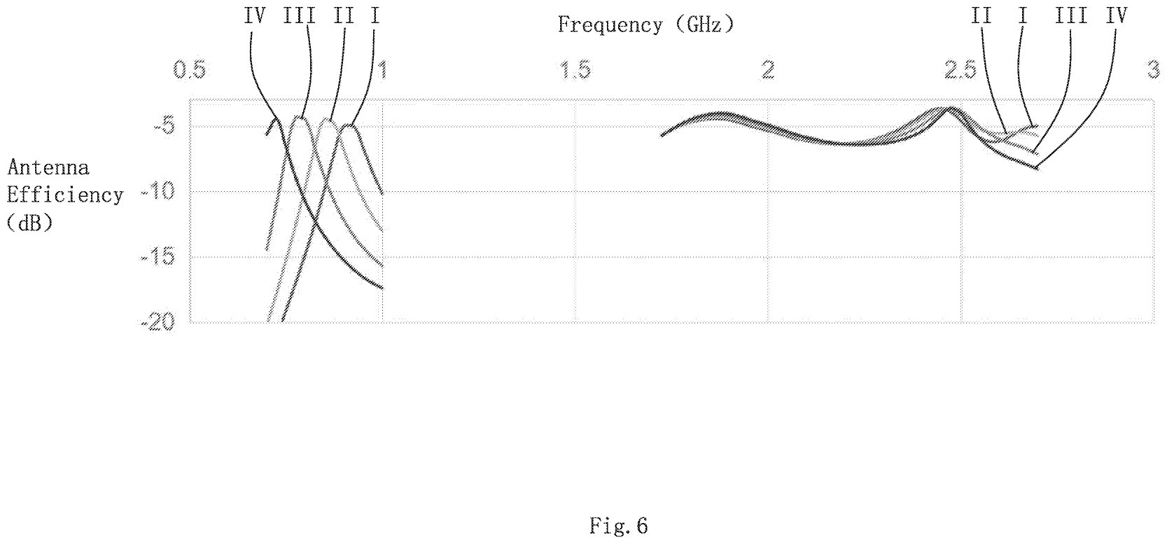

FIG. 6 shows the radiating efficiency of an antenna module according to the first embodiment of the present invention. The antenna module covers low frequency bands though harmonics in four states by using the tuning circuit 80. Antenna efficiencies in the four states are respectively represented by the curves I, II, III and IV.

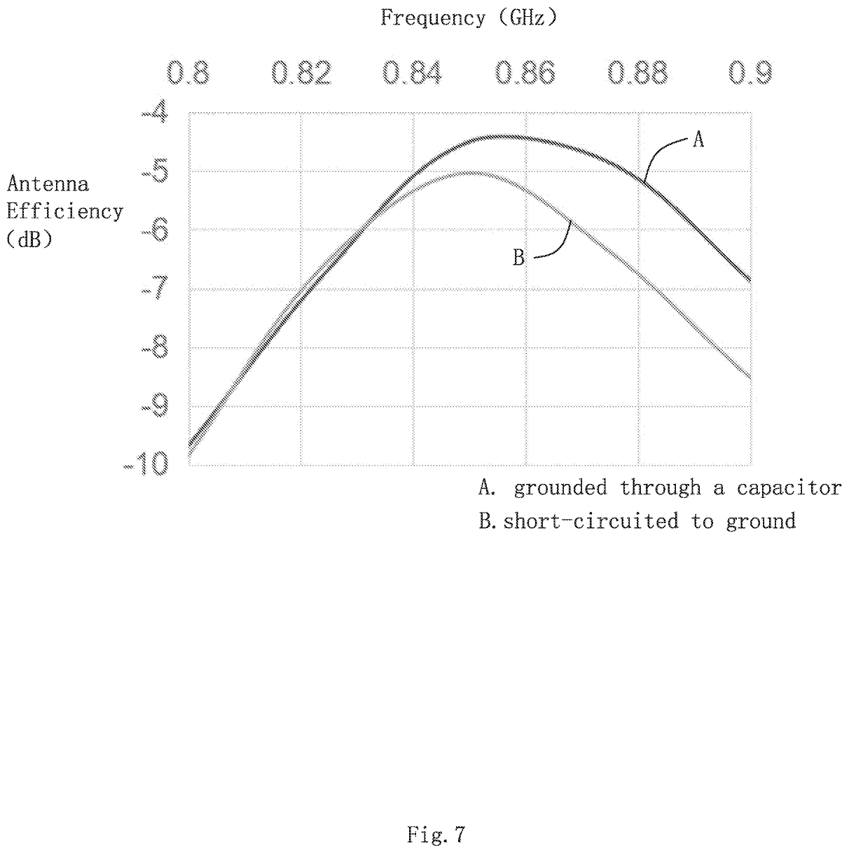

FIG. 7 illustrates the comparation of radiating efficiencies in the situation where the parasitic element is short-circuited to ground and in the situation where the parasitic element is grounded via a capacitor. The curve A shows the radiating efficiency in the situation where the parasitic element 32 is grounded via the capacitor 70. The curve B shows the radiating efficiency in the situation where the parasitic element 32 is short-circuited to ground. By comparing the curves A and B, it is known that implementing the capacitor 70 improves low frequency efficiency (the frequency bands having −6 dB efficiency may be enlarged about 30%).

The antenna module of the present invention generates the LTE low frequency harmonic through the metal frame and generates the medium and high frequency harmonics through the parasitic element, and achieves carrier aggregation of the low, medium and high harmonics. By connecting a small capacitance between the parasitic element and the system grounding, interference of the parasitic element to the low frequency harmonic may be significantly reduced, which improves the low frequency performance of the antenna. Furthermore, the antenna module of the present invention only takes very small space. Thus, the other portion of the metal frame may be utilized to set other antennae, for example, MIMO antennae, Wi-Fi antennae, which may meet further antenna design requirements.

It should be noted that, the above are merely embodiments of the present invention, and further modifications can be made for those skilled in the art without departing from the inventive concept of the present invention. However, all these modifications shall fall into the protection scope of the present invention.

What is claimed is:

1. An antenna module for a mobile terminal, wherein
the mobile terminal comprises a metal frame and a system grounding spaced apart from the metal frame;
the antenna module comprises a radiating body formed on the metal frame and a parasitic element electrically connected to the system grounding and coupled to the radiating body, the radiating body is capable of generating LTE low frequency harmonic, the parasitic element is capable of generating LTE medium frequency harmonic and LTE high frequency harmonic;
where in, the antenna module supports carrier aggregation of the LTE low frequency harmonic, the LTE medium frequency harmonic and the LTE high frequency harmonic;
the antenna module further comprises a capacitor connected in series between the parasitic element and the system grounding, and a capacitance of the capacitor is less than 0.8 pF.

2. The antenna module of claim 1, where in the LTE low frequency harmonic covers 698-960 MHz, the LTE medium frequency harmonic covers 1710-2170 MHz, and the LTE high frequency harmonic covers 2300-2690 MHz.

3. The antenna module of claim 1, further comprising a connector which connects the metal frame and the system grounding, wherein the metal frame defines a gap, the radiating body is form by a portion of the metal frame located between the connector and the gap, the antenna module further comprises a feed line electrically connected to the radiating body.

4. The antenna module of claim 3, further comprising a tuning circuit configured to tune low frequency harmonics, wherein the tuning circuit is an adjustable capacitor or a radio frequency switch.

5. The antenna module of claim 4, wherein the tuning circuit is connected to the feed line in series.

6. The antenna module of claim 4, further comprising a grounding line spaced apart from the feed line, wherein the tuning circuit is connected to the grounding line in series.

7. The antenna module of claim 3, wherein the mobile terminal comprises a shorter side frame extending along a shorter axis of the mobile terminal and a longer side frame extending along a longer axis of the mobile terminal, the connector is connected to one of the shorter side frame, a distance between the connector and an end of the radiating body away from the connector is no larger than ⅔ of a length of the one of the shorter side frame.

8. The antenna module of claim 7, wherein the gap is located in one of the longer side frame or the shorter side frame.

9. The antenna module of claim 3, wherein the parasitic element is located at a side of the feed line away from the connector.

10. A mobile terminal, comprising the antenna module of claim 1.

11. The mobile terminal of claim 10, where in the LTE low frequency harmonic covers 698-960 MHz, the LTE medium frequency harmonic covers 1710-2170 MHz, and the LTE high frequency harmonic covers 2300-2690 MHz.

12. The mobile terminal of claim 10, further comprising a connector which connects the metal frame and the system grounding, wherein the metal frame defines a gap, the radiating body is form by a portion of the metal frame located between the connector and the gap, the antenna module further comprises a feed line electrically connected to the radiating body.

13. The mobile terminal of claim 10, further comprising a tuning circuit configured to tune low frequency harmonics, wherein the tuning circuit is an adjustable capacitor or a radio frequency switch.

14. The mobile terminal of claim 10, wherein the tuning circuit is connected to the feed line in series.

15. The mobile terminal of claim 10, further comprising a grounding line spaced apart from the feed line, wherein the tuning circuit is connected to the grounding line in series.

16. The mobile terminal of claim 10, wherein the mobile terminal comprises a shorter side frame extending along a shorter axis of the mobile terminal and a longer side frame extending along a longer axis of the mobile terminal, the connector is connected to one of the shorter side frame, a distance between the connector and an end of the radiating body away from the connector is no larger than ⅔ of a length of the one of the shorter side frame.

17. The mobile terminal of claim 10, wherein the gap is located in one of the longer side frame or the shorter side frame.

18. The mobile terminal of claim 10, wherein the parasitic element is located at a side of the feed line away from the connector.
